(19) United States
(12) Patent Application Publication
(10) Pub. No.: US 2015/0183970 A1
(43) Pub. Date: Jul. 2, 2015

(54) Rubber Composition, and Vulcanized Rubber Product and Hose Using Same

(71) Applicant: The Yokohama Rubber Co., LTD, Minato-ku, Tokyo (JP)

(72) Inventors: Tomoaki Miyamoto, Hiratsuka-shi (JP); Yasuaki Shinoda, Hiratsuka-shi (JP)

(21) Appl. No.: 14/408,930

(22) PCT Filed: Jul. 1, 2013
(86) PCT No.: PCT/JP2013/068059

§ 371 Date: Dec. 17, 2014

(30) Foreign Application Priority Data
Jul. 2, 2012 (JP) 2012-148583

(51) Int. Cl. C08L 9/06; F16L 11/14; F16L 11/08; C08L 11/00; C08L 9/02

(52) U.S. Cl. CPC C08L 9/06; C08L 11/00; C08L 9/02; F16L 11/08; F16L 11/14; C08L 2207/068; C08L 2205/02; C08L 2205/03; C08L 2205/035

(57) ABSTRACT

To provide a rubber composition having excellent durability against external environment, and a vulcanization rubber product and a hose using the same. The rubber composition of the present technology is a rubber composition comprising: a rubber component (A), a water repellent (B), and hydrotalcite (C). In the rubber composition, the rubber component (A) comprises CR, SBR, or both CR and SBR; and the water repellent (B) comprises one or more types of ultra high molecular weight polyethylene powders or fatty acid amide compounds. The total content of the components of the water repellent (B) is from 2 parts by mass to 30 parts by mass per 100 parts by mass of the rubber component (A); and the content of the hydrotalcite (C) is from 2 parts by mass to 20 parts by mass per 100 parts by mass of the rubber component (A).

### TECHNICAL FIELD

The present technology relates to a rubber composition, a vulcanized rubber product and a hose using the same. The present technology particularly relates to a rubber composition which, in hoses such as a hydraulic hose having a reinforcing layer plated with brass including a brass-plated wire and the like, has excellent durability against the external environment by mitigating corrosion of brass-plated wires of a hydraulic hose, and a vulcanized rubber product and a hose using the same.

### BACKGROUND

A hydraulic hose contains a rubber inner layer having corrosion resistance against fluid, a reinforcing layer enhancing pressure resistance and having the brass-plated surface disposed adjacent to the outer circumferential side of the rubber inner layer, and a rubber outer layer disposed adjacent to the outer circumferential side of the reinforcing layer. For the outer layer rubber of a hydraulic hose, oil resistance and weatherability (especially ozone resistance) are required. Furthermore, since these hoses often have a reinforcing layer plated with brass such as brass (Cu—Zn alloy)-plated wires, a rubber compositions employed in the outer layer rubber is also required to have vulcanization adhesion toward metals such as brass.

Therefore, as the outer layer rubber of hydraulic hoses, rubber comprising chloroprene rubber (CR), which generally exhibits excellent oil resistance, weatherability, and vulcanization adhesion toward brass-plated wires, as a main component has been conventionally used.

As the rubber composition containing rubber having CR as a main component, a rubber composition for a hose jacket comprising at least a butadiene polymer containing 1,3-butadiene monomer unit and CR as rubber components wherein each of the components are compounded at predetermined amounts per 100 parts by weight of the rubber component has been proposed (e.g. see Japanese Unexamined Patent Application Publication No. 2010-121006A).

Furthermore, in addition to CR, as rubber components for enhancing oil resistance and weatherability, rubber composition for a hose jacket comprising predetermined proportions of ethylene-propylene-non-conjugated diene rubber (EPDM) and acrylonitrile-butadiene rubber (NBR) has been proposed (e.g. see Japanese Unexamined Patent Application Publication No. 2005-188607A and Japanese Patent No. 4299881B).

Furthermore, for cases where a hydraulic hose or the like is used at ports or similar places where effect from environment, such as salt damage, is great, for example, permeation of rain water into the inside of a hose outer layer is suppressed by performing a sealing treatment at a boundary between the hose outer layer and a reinforcing layer (e.g. see Japanese Unexamined Patent Application Publication No. H08-075067A).

Hydraulic hoses placed at ports or similar places are readily damaged by salts from salt water since heavy machines using hydraulic pressure and the like are brought into contact with salt water such as sea water. A cause of the salt damage is that the hydraulic hoses, heavy machines using hydraulic pressure, or the like are directly exposed to salt water. Another cause of the salt damage is that salt dispersed in the air transported by sea breezes is attached and deposited on a surface of a hydraulic hose or a heavy machine using hydraulic pressure, and then becomes salt-containing water when the salt deposited on the surface of the hydraulic hose or the heavy machine using hydraulic pressure or the like is dissolved when it rains. Another cause of the salt damage is that, when it rains, salt floated in the air precipitates with rain.

It has been difficult to suppress the permeation of salt water such as sea water for a long period of time even when the boundary between the hose outer layer and the reinforcing layer had been undergone a sealing treatment. Therefore, once the salt water attaches to the surface of the hose outer layer rubber and permeates into the inside of the hose outer layer rubber, chlorine ion reacts with brass-plated wires and corrodes the brass-plated wires. Once the brass-plated wires have been rusted, strength of the hydraulic hose is lowered.

Furthermore, in order to avoid bursting the hydraulic hose due to decrease in the strength, the hose must be replaced with a new hose before the hydraulic hose is burst, from the perspective of safety.

Therefore, demands has been increased for a rubber composition that can maintain oil resistance and exhibit high weatherability even at a place where a hydraulic hose is readily deteriorated by effect of external environment such as salt damage at ports or similar places, and that has excellent vulcanization adhesion toward brass-plated wires. Therefore, a rubber composition having high deterioration resistance performance (durability) against external environment in which a rubber composition is readily affected by the environment has been desired.

### SUMMARY

The present technology provides a rubber composition having excellent durability against external environment, and a vulcanization rubber product and a hose using the same.

The present inventors have found that a rubber composition having excellent oil resistance, weatherability, and adhesion toward brass, as well as exhibiting excellent durability against external environment is obtained by, in a rubber composition comprising a rubber component (A), a water repellent (B), and hydrotalcite (C), using chloroprene rubber and styrene-butadiene rubber, or ethylene-propylene-non-conjugated diene rubber, acrylonitrile-butadiene rubber, and styrene-butadiene rubber as the rubber component (A), using one or more types of ultra high molecular weight polyethylene powders or fatty acid amide compounds as the water repellent (B), and compounding specific amounts of the rubber component (A), the water repellent (B), and the hydrotalcite (C). The present technology has been completed based on this finding.

The present technology is described in the following (1) to (9).

(1) A rubber composition comprising: a rubber component (A), a water repellent (B), and hydrotalcite (C);

the rubber component (A) comprising chloroprene rubber, styrene-butadiene rubber, or both chloroprene rubber and styrene-butadiene rubber;

the water repellent (B) comprising one or more types of ultra high molecular weight polyethylene powders or fatty acid amide compounds;

a total content of the components of the water repellent (B) being from 2 parts by mass to 30 parts by mass per 100 parts by mass of the rubber component (A); and

a content of the hydrotalcite (C) being from 2 parts by mass to 20 parts by mass per 100 parts by mass of the rubber component (A).

(2) A rubber composition comprising: a rubber component (A), a water repellent (B), and hydrotalcite (C);

the rubber component (A) comprising ethylene-propylene-non-conjugated diene rubber, acrylonitrile-butadiene rubber, and styrene-butadiene rubber;

the water repellent (B) comprising one or more types of ultra high molecular weight polyethylene powders or fatty acid amide compounds;

a content of the ethylene-propylene-non-conjugated diene rubber in the rubber component (A) being from 20 parts by mass to 35 parts by mass, a content of the acrylonitrile-butadiene rubber being from 30 parts by mass to 50 parts by mass, and a content of the styrene-butadiene rubber being from 25 parts by mass to 50 parts by mass;

a total content of the components of the water repellent (B) being from 2 parts by mass to 30 parts by mass per 100 parts by mass of the rubber component (A); and

a content of the hydrotalcite (C) being from 2 parts by mass to 20 parts by mass per 100 parts by mass of the rubber component (A).

(3) The rubber composition according to (1) above, wherein, upon the rubber component (A) comprising both the chloroprene rubber and the styrene-butadiene rubber, a content of the chloroprene rubber is 40 parts by mass or greater but less than 100 parts by mass, and a content of the styrene-butadiene rubber is greater than 0 parts by mass but 60 parts by mass or less.

(4) The rubber composition according to any one of (1) to (3) above, wherein the rubber composition is a rubber composition for hose.

(5) A vulcanized rubber product obtained by vulcanizing the rubber composition described in any one of (1) to (4) above.

(6) The vulcanized rubber product according to (5) above, comprising a rubber layer obtained by vulcanizing the rubber composition described in any one of (1) to (4) above, and a reinforcing layer having a brass-plated surface disposed adjacent to the rubber layer.

(7) The vulcanized rubber product according to (5) or (6) above, wherein the vulcanized rubber product is a hose.

(8) The vulcanized rubber product according to (5) or (6) above, wherein the vulcanized rubber product is a hydraulic hose.

(9) A hose comprising: a rubber inner layer, a reinforcing layer having a brass-plated surface disposed adjacent to an outer circumferential side of the rubber inner layer, and an rubber outer layer disposed adjacent to an outer circumferential side of the reinforcing layer;

the rubber inner layer, the rubber outer layer, or both the rubber inner layer and the rubber outer layer being formed by the rubber composition described in any one of (1) to (4) above.

According to the rubber composition of the present technology, a rubber composition having excellent durability against external environment can be achieved.

Furthermore, since a vulcanized rubber product and a hose of the present technology use the rubber composition of the present technology as a rubber component, the vulcanized rubber product and the hose of the present technology can be used stably for a long period of time due to the excellent durability against external environment.

### BRIEF DESCRIPTION OF THE DRAWINGS

FIG. 1 is a perspective view illustrating a cutaway of each layer of a hose.

FIG. 2 is a perspective view illustrating a cutaway of each layer of a hose that is an example of another configuration of a hose.

FIG. 3 is a plan view illustrating a cutaway of a rubber/wire composite, in which a part of a rubber layer of the rubber/wire composite has been cut away, having brass-plated wires in the rubber layer.

FIG. 4 is a view illustrating a state where the rubber/wire composite is immersed in salt water.

### DETAILED DESCRIPTION

The present technology is explained in detail below. However, the present technology is not limited by the embodiments of the technology (hereinafter referred to as “embodiments”) described hereinafter. Furthermore, the constituents described in the embodiments include constituents that could be easily conceived by a person skilled in the art and constituents that are essentially identical, or, in other words, are equivalent in scope. Moreover, the constituents described in the embodiments can be combined as desired.

### <Rubber Composition>

The rubber composition according to the present embodiment (hereinafter referred to as “composition of the present embodiment”) is a rubber composition comprising a rubber component (A), a water repellent (B), and hydrotalcite (C).

### [Rubber Component (A)]

The rubber component (A) contains at least one type selected from the group consisting of chloroprene rubber (CR), styrene-butadiene rubber (SBR), ethylene-propylene-non-conjugated diene rubber (EPDM), and acrylonitrile-butadiene rubber (NBR). In the present embodiment, the rubber component (A) contains CR and/or SBR or contains EPDM, NBR, and SBR.

For cases where the rubber component (A) contains CR and/or SBR, the content of the CR and the SBR is not particularly limited. The content of the CR in the rubber component (A) is preferably 40 parts by mass or greater but less than 100 parts by mass. If the content of the CR is less than 40 parts by mass, oil resistance will be insufficient. Furthermore, from the perspectives of exhibiting oil resistance, weatherability, and wear resistance, the content of the CR is more preferably from 50 parts by mass to 80 parts by mass, and even more preferably from 60 parts by mass to 70 parts by mass.

The SBR is a copolymer of styrene and butadiene, and a common SBR can be used without any particular limitations. For cases where the rubber component (A) contains only SBR, or SBR and another optional rubber other than CR, from the perspective of exhibiting excellent vulcanization adhesion toward brass, the content of the SBR is preferably 60 parts by mass or greater but less than 100 parts by mass.

For cases where the rubber component (A) contains both CR and SBR, the content of the SBR in the rubber component (A) is preferably greater than 0 parts by mass but 60 parts by mass or less. If the content of the SBR exceeds 60 parts by mass, oil resistance and weatherability will be insufficient. Furthermore, from the perspectives of exhibiting excellent oil resistance, weatherability, and vulcanization adhesion toward brass, the content of the SBR in the rubber component (A) is more preferably from 20 parts by mass to 50 parts by mass, and even more preferably from 20 parts by mass to 40 parts by mass.

For cases where the rubber component (A) contains EPDM, NBR, and SBR, the content of the SBR in the rubber component (A) is from 25 parts by mass to 50 parts by mass. If the content of the SBR is less than 20 parts by mass, vulcanization adhesion toward brass will be insufficient. If the content of the SBR exceeds 50 parts by mass, oil resistance and weatherability will be insufficient. Furthermore, from the perspectives of exhibiting excellent oil resistance, weatherability, and vulcanization adhesion toward brass, the content of the SBR in the rubber component (A) is preferably from 30 parts by mass to 40 parts by mass, and more preferably from 35 parts by mass to 40 parts by mass.

The EPDM is a terpolymer of ethylene, propylene, and diene, and a common EPDM can be used without any particular limitations.

For cases where the rubber component (A) contains EPDM, NBR, and SBR, the content of the EPDM in the rubber component (A) is from 20 parts by mass to 35 parts by mass. If the content of the EPDM is less than 20 parts by mass, weatherability will be insufficient. If the content of the EPDM exceeds 35 parts by mass, oil resistance will be insufficient. Furthermore, from the perspectives of exhibiting oil resistance and weatherability, the content of the EPDM in the rubber component (A) is preferably from 20 parts by mass to 30 parts by mass, and more preferably from 25 parts by mass to 30 parts by mass.

The NBR is a copolymer of butadiene and acrylonitrile, and a common NBR can be used without any particular limitations. From the perspectives of exhibiting oil resistance and low temperature resistance, the average amount of bonded acrylonitrile in the NBR is preferably from 15 mass % to 50 mass %, and more preferably from 20 mass % to 45 mass %.

For cases where the rubber component (A) contains EPDM, NBR, and SBR, the content of the NBR in the rubber component (A) is from 30 parts by mass to 50 parts by mass. If the content of the NBR is less than 30 parts by mass, oil resistance will be insufficient. If the content of the NBR exceeds 50 parts by mass, low temperature resistance will be insufficient. Furthermore, from the perspectives of exhibiting oil resistance and low temperature resistance, the content of the NBR in the rubber component (A) is preferably from 30 parts by mass to 45 parts by mass, and more preferably from 35 parts by mass to 45 parts by mass.

For cases where the rubber component (A) contains CR and/or SBR, the rubber component (A) may contain another rubber (hereinafter called “other rubber”) other than the CR and the SBR in a range that does not impair the effect of the present technology. Examples of this other rubber include natural rubber (NR), epoxidized natural rubber (ENR), isoprene rubber (IR), acrylonitrile-isoprene rubber (NIR), butadiene rubber (BR), NBR, EPDM, butyl rubber (IIR) and a halide thereof, hydrogenated nitrile rubber (HNBR), acrylic rubber (ACM), styrene-isoprene-butadiene rubber (SIBR), carboxylated butadiene rubber (XBR), carboxylated nitrile rubber (XNBR), carboxylated styrene butadiene rubber (XSBR), ethylene-vinyl acetate copolymer (EVM), ethylacrylate-acrylonitrile copolymer (ANM), ethylacrylate-ethylene copolymer (AEM), and the like. The content of the other rubber in the rubber component (A) is preferably 30 parts by mass or less, and more preferably 0 parts by mass.

For cases where the rubber component (A) contains EPDM, NBR, and SBR, the rubber component (A) may contain another rubber (hereinafter called “other rubber”) other than the EPDM, the NBR, and the SBR in a range that does not impair the effect of the present technology. Examples of this other rubber include natural rubber (NR), epoxidized natural rubber (ENR), isoprene rubber (IR), acrylonitrile-isoprene rubber (NIR), butadiene rubber (BR), butyl rubber (IIR) and a halide thereof, hydrogenated nitrile rubber (HNBR), acrylic rubber (ACM), styrene-isoprene-butadiene rubber (SIBR), carboxylated butadiene rubber (XBR), carboxylated nitrile rubber (XNBR), carboxylated styrene butadiene rubber (XSBR), ethylene-vinyl acetate copolymer (EVM), ethylacrylate-acrylonitrile copolymer (ANM), ethylacrylate-ethylene copolymer (AEM), and the like. The content of the other rubber in the rubber component (A) is preferably 30 parts by mass or less, and more preferably 0 parts by mass.

### [Water Repellent (B)]

A water repellent forms a surface layer (water repellent film) having excellent water repellency by being transferred to the surface of vulcanized rubber and accumulated, thereby increasing the surface tension of the rubber composition. Therefore, by compounding the water repellent (B) in the rubber composition, even when the composition of the present embodiment is used as a rubber component for a hose, salt water hardly attaches to the rubber surface and penetration of chlorine ion inside the rubber can be suppressed.

Examples of water repellent (B) include ultra high molecular weight polyethylene (UHMWPE) powder, fatty acid amide compounds, dimethyl polysiloxane, dimethyl trimethyl polysiloxane, methyl phenyl polysiloxane, methyl hydrogen polysiloxane, and the like; epoxy-modified, carboxy-modified, alcohol-modified, or similar modified polysiloxane; polytetrafluoro ethylene, tetrafluoroethylene-perfluoroalkyl vinylether copolymers, tetrafluoroethylene-hexafluoropropylene copolymers, tetrafluoroethylene-hexafluoropropylene-perfluoroalkyl vinylether copolymers, tetrafluoroethylene-ethylene copolymers, polychlorotrifluoroethylene, polyvinylidene fluoride, polyvinyl fluoride, and the like. One type of these water repellents can be used alone, a combination of two or more types of these water repellents can be used. In the present embodiment, the water repellent (B) is particularly preferably ultra high molecular weight polyethylene powder or a fatty acid amide compound. Note that the ultra high molecular weight polyethylene is a polyethylene having a viscosity average molecular weight of 1,000,000 or greater. Note that the fatty acid amide compound is a reaction product of saturated fatty acid or unsaturated fatty acid and amine, and the fatty acid amine compound in which the number of carbon included in the fatty acid (in the case where there are two or more amide groups, this number is a number of carbon per one amide group) is from 10 to 22 can be suitably used. Examples of the fatty acid amide compound include oleamide, stearic acid amide, hydroxystearic acid amide, palmitic acid amide, erucic acid amide, behenic acid amide, lauric acid amide, methylene-bisstearic acid amide, ethylene-bisstearic acid amide, ethylene-bisoleamide, and the like.

The content of the water repellent in the composition of the present embodiment is from 2 parts by mass to 30 parts by mass per 100 parts by mass of the rubber component (A), and from the perspective of balancing the water repellent effect and the physical properties of the vulcanized rubber product which is a molded product thereof, the content of the water repellent is preferably from 5 parts by mass to 20 parts by mass. If the content of the water repellent is less than 2 parts by mass, water repellency will be insufficient. If the content of the water repellent exceeds 30 parts by mass, severe bloom (exuding to a surface) is caused and impairs the appearance.

### [Hydrotalcite (C)]

The hydrotalcite (C) can be used as a halogen catcher. Other than the hydrotalcite (C), examples of the halogen catcher include magnesium oxide, calcium hydroxide, and the like. When the halogen catcher such as the hydrotalcite (C) is used as an outermost layer of the rubber component constituting a hose, the hydrotalcite (C) hardly release a halogen once it traps the halogen, thereby enhancing the safety to the environment. Therefore, for cases where the water repellent (B) and the hydrotalcite (C) are contained as rubber components constituting a hose, assuming a few amount of salt water permeates a water repellent surface layer (water repellent film) that is formed by the water repellent (B) and that is formed on the surface of the rubber layer, the hydrotalcite (C) can suppress progress of corrosion of brass-plated wires by trapping chlorine ions that catalyze a corrosion reaction.

The hydrotalcite (C) is not particularly limited. The hydrotalcite (C) may be a natural or a synthetic hydrotalcite. Examples thereof include Mg₃ZnAl₂(OH)₁₂CO₃.wH₂O (wherein, w represents a positive real number), MgₓAl_{y}(OH)_{2x+3y-2}CO₃.wH₂O (wherein, x is from 1 to 10, y is from 1 to 10, and w represents a positive real number), MgₓAl_{y}(OH)_{2x+3y-2}CO₃ (wherein, x is from 1 to 10 and y is from 1 to 10; e.g. Mg_{4.3}Al₂(OH)_{12.6}CO₃ (trade name: DHT-4A-2, manufactured by Kyowa Chemical Industry Co., Ltd.)), and Mg₁₋ₓAlₓO_{3.83x} (0.2≦x<0.5; e.g. Mg_{0.7}Al_{0.3}O_{1.15} (trade name: KW-2200, manufactured by Kyowa Chemical Industry Co., Ltd.)).

The hydrotalcite reacts with an acid (e.g. a substance containing a halogen; hereinafter, an example is described using hydrochloric acid) to trap the halogen as described in formulas (1) and (2) below:

Mg_{4.3}Al₂(OH)_{12.6}CO₃+2HCl→Mg_{4.3}Al₂(OH)_{12.6}Cl₂+H₂O+CO₂ (1)

Mg_{0.7}Al_{0.3}O_{1.15}+0.3HCl+0.85H₂O→Mg_{0.7}Al_{0.3}(OH)₂Cl_{0.3} (2)

The halogen trapped by the hydrotalcite (C) and contained in a reaction product is not released from the reaction product as long as the reaction product does not decompose as a result of heating at 450° C. or higher. A maximum usage temperature of hoses such as hydraulic hoses is approximately 180° C. Therefore, in cases where the composition of the present embodiment is used in a rubber component constituting these hoses, as hydraulic hoses at ports or similar places, there is a benefit in that trapped halogen will not be released. From this perspective, the composition of the present embodiment preferably contains the hydrotalcite (C) as an acid acceptor.

Among these, the hydrotalcite (C) is preferably a hydrotalcite having a small amount of hydroxyl group (OH group), preferably Mg₁₋ₓAlₓO_{3.83x}, and more preferably Mg_{0.7}Al_{0.3}O_{1.15}, from the perspective of exhibiting higher halogen catching capacity. The hydrotalcite having a low OH group content in the chemical structure can be produced by baking a hydrotalcite obtained via synthesis at an elevated temperature.

A commercially available product can be used as the hydrotalcite. Examples of commercially available hydrotalcites include the DHT series (DHT-4A and DHT-4A-2: calcination treatment is performed, but the products are not ignited to the extent of KW-2200 of the KW series described below; DHT-4C) manufactured by Kyowa Chemical Industry Co., Ltd., the KW series (a grade resulting from performing calcination treatment at a higher temperature than for the DHT series; the halogen catching capacity tends to be higher than the DHT series; KW-2000, KW-2100, and KW-2200) also manufactured by Kyowa Chemical Industrial Co., Ltd., and the STABIACE HT series manufactured by Sakai Chemical Industry Co., Ltd.

The hydrotalcite (C) may be a natural or a synthetic hydrotalcite. When the hydrotalcite (C) is a synthetic hydrotalcite, a production method thereof may be a conventionally known method. Hydrotalcite that has undergone surface treatment or hydrotalcite that has not undergone surface treatment (so that the surface of the hydrotalcite is untreated) may be used as the hydrotalcite (C). Examples of surface treating agents to be used when performing surface treatment on hydrotalcite include fatty acids (including higher fatty acids) and fatty acid esters. From the perspective of achieving high halogen catching capacity, it is preferable for the hydrotalcite (C) to be one that has not undergone surface treatment. Examples of commercially available hydrotalcites that have not undergone surface treatment include KW-2200 (manufactured by Kyowa Chemical Industry Co., Ltd.) and DHT-4C (manufactured by Kyowa Chemical Industry Co., Ltd.). One type of these can be used alone as the hydrotalcite (C), a combination of two or more types of these can be used as the hydrotalcite (C).

In the present embodiment, the content of the hydrotalcite (C) is from 2 parts by mass to 20 parts by mass per 100 parts by mass of the rubber component (A). If the content of the hydrotalcite (C) is less than 2 parts by mass, proportion of the hydrotalcite (C) reacting with chlorine ions will be lower. If the content of the hydrotalcite (C) exceeds 20 parts by mass, viscosity of the rubber composition will increase, leading to decrease rubber processability. For cases where the hydrotalcite (C) is contained as a rubber component of the outermost layer constituting a hose, by adjusting the content of the hydrotalcite (C) within the range described above, it is possible to impart excellent deterioration resistance to the outermost layer of the hose and suppress corrosion of brass-plated wires of the reinforcing layer contained in the hose. Furthermore, from the perspectives of exhibiting excellent deterioration resistance of the outermost layer and having excellent flexibility (flexibility of the outermost layer and the entire hose), the content of the hydrotalcite (C) is preferably from 3 parts by mass to 15 parts by mass, and more preferably from 5 parts by mass to 15 parts by mass, per 100 parts by mass of the rubber component (A).

### [Vulcanizing Agent]

The composition of the present embodiment further contains a vulcanizing agent. Examples of the vulcanizing agent include sulfurs such as powdered sulfur, precipitated sulfur, highly dispersible sulfur, surface-treated sulfur, and insoluble sulfur; and organic-containing sulfur compounds such as dimorpholine disulfide and alkylphenol disulfide. The content of the vulcanizing agent is preferably from 0.1 parts by mass to 5.0 parts by mass, and more preferably 1.0 parts by mass to 3.0 parts by mass, per 100 parts by mass of the rubber component (A).

Furthermore, the composition of the present embodiment can use an organic peroxide together with the vulcanizing agent described above or instead of the vulcanizing agent described above. Here, the organic peroxide is not particularly limited as long as it is an organic peroxide that is commonly used in crosslinking of rubber; however, the organic peroxide is preferably an organic peroxide by which crosslinking reaction does not proceed excessively in the rubber composition at a temperature of processing, and more preferably has a decomposition temperature (a temperature at which the half-life thereof becomes 10 hours) of 80° C. or greater.

Specific examples of the organic peroxide include dicumylperoxide, di-t-butylperoxide, 1,3-bis(t-butylperoxyisopropyl)benzene, n-butyl 4,4′-di(t-butylperoxy)valeric acid, 2,5-dimethyl-2,5-bis(t-butylperoxy)hexane, and the like.

In the present embodiment, the content of the organic peroxide is not particularly limited since the content also depends on the amount of active oxygen of the organic peroxide; however, the content of the organic peroxide is from 0.5 parts by mass to 15 parts by mass, and is preferably from 1 part by mass to 15 parts by mass, per 100 parts by mass of the rubber component (A). If the content of the organic peroxide is within the range described above, crosslinking density of the obtained rubber composition of the present technology will be suitable, and tensile stress and elongation at break will be excellent.

### [Vulcanization Accelerator]

The composition of the present embodiment preferably further comprises a vulcanization accelerator. Examples of the vulcanization accelerator include aldehyde-ammonia-based vulcanization accelerator, aldehyde-amine-based vulcanization accelerator, thiourea-based vulcanization accelerator, guanidine-based vulcanization accelerator, thiazole-based vulcanization accelerator, sulfenamide-based vulcanization accelerator, dithiocarbamate-based vulcanization accelerator, xanthogenate-based vulcanization accelerator, and the like. One of these may be used alone, or two or more of these may be used in any combination. Of these, sulfenamide-based vulcanization accelerator is preferable from the perspectives of exhibiting excellent covulcanization properties of the rubber component (A) and exhibiting the best mechanical strength of rubber.

Examples of the sulfenamide-based vulcanization accelerator include delayed-action accelerators of sulfenamides such as N-cyclohexyl-2-benzothiazolesulfenamide, N-t-butyl 2-benzothiazolesulfenamide, N,N-diisopropyl-2-benzothiazolesulfenamide, and N,N-dicyclohexyl-2-benzothiazyl sulfenamide.

The content of the vulcanization accelerator is preferably from 0.1 parts by mass to 5.0 parts by mass, and more preferably 1.0 parts by mass to 3.0 parts by mass, per 100 parts by mass of the rubber component (A).

The composition of the present embodiment preferably further comprises carbon black. Containing the carbon black results in excellent rubber properties such as excellent tensile strength and wear resistance of the rubber. Examples of the carbon black include furnace black, acetylene black, Ketjen black, thermal black, and the like.

Examples of the furnace black include super abrasion furnace (SAF), intermediate super abrasion furnace (ISAF), intermediate ISAF-high structure (IISAF-HS), high abrasion furnace (HAF), fast extruding furnace (FEF), general purpose furnace (GPF), semi-reinforcing furnace (SRF), and the like.

Examples of the thermal black include fine thermal (FT), medium thermal (MT), and the like.

From the perspectives of reinforcement and extrusion processability of rubber, the carbon black is preferably ISAF carbon black, HAF carbon black, FEF carbon black, GPF carbon black, and SRF carbon black, and more preferably FEF carbon black, GPF carbon black, and SRF carbon black. One of these may be used alone, or two or more of these may be used in any combination.

The content of the carbon black is preferably from 20 parts by mass to 150 parts by mass, and more preferably from 40 parts by mass to 90 parts by mass, per 100 parts by mass of the rubber component (A).

The rubber composition of the present embodiment may, as necessary, contain various additives such as fillers, antiaging agents, vulcanization activators, antiscorching agents, tackifiers, lubricants, dispersants, processing aids, and vulcanization adhesives such as triazine derivatives, phenolic resins, resorcin, and organic acid cobalt salts.

The method of producing the rubber composition of the present embodiment is not particularly limited. For example, the rubber composition of the present technology can be obtained by kneading essential and optional components except the vulcanizing agent and the vulcanization accelerator described above for 5 minutes using a 3.4-liter Banbury mixer, discharging the mixture as a master batch when it reaches 160° C., adding the vulcanizing agent and the vulcanization accelerator to this mixture, and then kneading the mixture with an open roll. Furthermore, by vulcanizing this rubber composition under appropriate conditions, the vulcanized rubber product of the present technology can be obtained.

Therefore, compounding the rubber component (A), the water repellent (B), and the hydrotalcite (C) each at the above-described specific proportions makes it possible for the rubber composition of the present embodiment to have oil resistance and weatherability in a well-balanced manner, as well as to have excellent adhesion toward brass and excellent durability against external environment. Therefore, when the rubber composition of the present embodiment is used as a rubber component of a hydraulic hose, the hydraulic hose can be used stably for a long period of time since the rubber composition of the present technology has excellent durability against external environment.

That is, when the rubber composition of the present embodiment is used as a rubber component of a hose having a reinforcing layer with a brass-plated surface therein, it is possible to suppress penetration of water, such as salt water, from the hose surface to inside the hose by making the surface of the rubber composition hydrophobic using the water repellent (B). Therefore, since deterioration of the rubber component can be suppressed and since rusting of brass-plated wires inside can be suppressed, product life of the hose can be extended. Furthermore, even for cases such that the surface of the hose is cracked or the like and water permeates from the surface, since the hydrotalcite (C) traps halogen ions, it is possible to suppress rusting of the brass-plated wires in the reinforcing layer due to the halogen ions.

Therefore, when the rubber composition of the present embodiment is used as a rubber component constituting a hydraulic hose, durability of the hose significantly increases and the hose can be used stably for a long period of time since the rubber component has excellent durability against external environment and makes it possible to suppress corrosion of the brass-plated wires in the reinforcing layer of the hydraulic hose.

Since the rubber composition of the present embodiment has excellent characteristics as described above, the rubber composition can be suitably used as a rubber composition for hoses.

The rubber composition of the present technology is useful as a rubber material for rubber/metal composite products used in the fields where oil resistance and weatherability are required. In particular, the rubber composition can be suitably used as an outer layer rubber of a hydraulic hose having a brass-plated, pressure resistant, reinforcing steel wire layer, and as a middle rubber used in between brass-plated, pressure resistant, reinforcing steel wire layers.

### <Vulcanized Rubber Product>

Next, the vulcanized rubber product of the present technology will be described. The vulcanized rubber product of the present embodiment is not particularly limited as long as it is a vulcanized rubber product obtained by vulcanizing the rubber composition of the present embodiment described above. Preferable examples thereof include a vulcanized rubber product comprising a rubber layer obtained by vulcanizing the rubber composition of the present embodiment, and a reinforcing layer having the surface adjacent to the rubber layer has been plated with brass.

Specific examples of the vulcanized rubber product of the present embodiment include hoses, conveyer belts, fenders, marine hoses, tires, and the like. The vulcanized rubber product is preferably a hose, and more preferably a hydraulic hose that transmits driving power by the pressure applied by the hydraulic oil filled in the hose and that is used in hydraulically-operated machines including construction machines such as power shovels and bulldozers, agricultural machines such as cultivators and tractors, other industrial equipment such as hydraulic jacks, hydraulic puncher, hydraulic press, and hydraulic bender, and the like.

### [Hose]

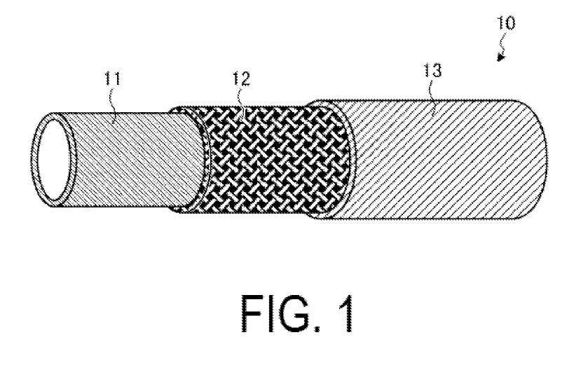

An example of a suitable mode of a hose of the present embodiment will be described using FIG. 1. FIG. 1 is a perspective view illustrating a cutaway of each layer of a hose. As illustrated in FIG. 1, a hose 10 of the present embodiment comprises a rubber inner layer 11, a reinforcing layer 12, and a rubber outer layer 13 laminated sequentially.

### (Rubber Layers (Rubber Inner Layer 11 and Rubber Outer Layer 13))

The rubber layer is a layer adjacent to the reinforcing layer described above. The hose 10 of the present embodiment comprises a rubber inner layer 11 and a rubber outer layer 13. In the present embodiment, the rubber inner layer 11 and/or the rubber outer layer 13 of the rubber layer is a layer formed by using the rubber composition of the present embodiment. From the perspectives of providing the hose 10 with oil resistance and weatherability in a well-balanced manner, excellent adhesion toward brass, and excellent durability against external environment, it is preferable to form at least the rubber outer layer 13 using the rubber composition of the present embodiment.

As the rubber composition used in the rubber inner layer 11 except for the composition of the present embodiment, a suitable rubber composition is selected and used from the perspectives of oil resistance, chemical resistance, processability, and the like. Examples of raw rubber include rubber compositions having, as a main component, at least one type of rubber selected from the group consisting of synthetic rubbers such as NBR, SBR, acrylic rubber, hydrin rubber, ethylene-acrylic ester-based copolymer rubber (in particular, AEM), and hydrogenated acrylonitrile-butadiene-based copolymer rubber. Furthermore, as necessary, the raw rubber may be a mixture with thermoplastic resin or a thermoplastic elastomer. The rubber composition used in the rubber inner layer 11 preferably has 4 MPa or greater, and more preferably has from 5 MPa to 20 MPa, of 100% modulus (M₁₀₀) after the vulcanization from the perspective of excellent durability of the hose. Note that, in the present specification, 100% modulus is a value measured in accordance with JIS K6251-2004.

As the rubber composition used in the rubber outer layer 13, it is preferable to use a rubber composition of the present embodiment; however, from the perspectives of exhibiting excellent durability against external environment, such as oil resistance, weatherability, and adhesion between the rubber layer and the reinforcing layer, a suitable rubber composition can be selected and used as the rubber outer layer 13.

Examples of raw rubber used in the rubber composition except for the rubber composition of the present embodiment include rubber compositions having, as a main component, at least one type of rubber selected from the group consisting of synthetic rubbers such as butyl-based copolymer rubber, ethylene-propylene-based copolymer rubber, EPDM, NBR, SBR, acrylic rubber, NR, BR, ethylene-acrylic ester-based copolymer rubber (in particular, AEM), hydrogenated NBR, and hydrin rubber. Furthermore, as necessary, the raw rubber may be a mixture with thermoplastic resin or a thermoplastic elastomer.

The rubber outer layer 13 is a layer provided adjacent to the outer circumferential side of the reinforcing layer 12. The rubber composition used in the rubber outer layer 13 preferably has 2 MPa or greater, and more preferably has from 3 MPa to 15 MPa, of 100% modulus (M₁₀₀) after the vulcanization from the perspective of excellent durability of the hose.

Furthermore, the rubber composition used in the rubber outer layer 13 preferably has abrasion capacity of 0.2 cm³ or less per 1000 rotations of an abrasion wheel, measured in accordance with Akron abrasion test (A method) of JIS K6264-2-2005, measured under the conditions: angle between the sample piece and the abrasion wheel being 15°; load on the abrasion wheel being 27 N; and rotation speed of the test sample being 75±5 rpm.

Furthermore, the rubber composition used in the rubber outer layer 13 preferably has a volume change (VC) of 100% or less, determined by immersion test in accordance with JIS K6258-2003 (IRM 903, 80° C., immersed for 72 hours).

In the hose 10 of the present embodiment, the thickness of the rubber inner layer 11 is preferably from 1.0 mm to 4.0 mm, and more preferably from 1.5 mm to 1.8 mm. At the same time, the thickness of the rubber outer layer 13 is preferably from 0.5 mm to 2.5 mm, and more preferably from 0.8 mm to 1.5 mm.

Although the rubber inner layer 11 is a single layer in the present embodiment, the present embodiment is not limited to this. For example, the rubber inner layer 11 can be a two-layer structure comprising an innermost layer (inner surface resin layer) and a rubber layer.

### (Reinforcing Layer)

The reinforcing layer 12 is a layer disposed adjacent to the outer circumferential side of the rubber inner layer 11 and having a surface plated with brass. The reinforcing layer 12 is formed on the outer side of the rubber inner layer 11 from the perspective of maintaining strength. In the present embodiment, the reinforcing layer 12 may be a layer formed having a blade shape or a layer formed having a helical shape. Two or more layers of the reinforcing layers 12 may be formed. For cases where two or more layers of the reinforcing layer 12 is formed, examples of the rubber composition used in the rubber intermediate layer between the reinforcing layers include rubber compositions having, as a main component, at least one type of rubber selected from the group consisting of synthetic rubbers such as NBR, NR, SBR, BR, EPDM, and ethylene-acrylic ester-based copolymer rubber (in particular, AEM). Furthermore, as necessary, the rubber composition may be a mixture with thermoplastic resin or a thermoplastic elastomer.

Materials for forming the reinforcing layer 12 is not particularly limited; however, the materials are suitably exemplified by metal materials such as hard steel wires (e.g. brass (Cu—Zn alloy)-plated wires, zinc-plated wires, and the like). As the reinforcing layer 12, a layer that has been plated with brass is preferable from the perspective of exhibiting excellent adhesion toward the rubber composition of the present embodiment.

The method of producing the hose 10 of the present embodiment having the rubber layer and the reinforcing layer 12 described above is not particularly limited, and a conventionally known method can be used. An example of the method of producing the hose 10 of the present embodiment will be explained. First, a rubber inner layer (inner tube rubber) 11 is formed by extrusion molding a rubber composition for rubber inner layer 11 on the outer side of a core (mandrel) having roughly the same diameter with the hose inner diameter so as to coat the mandrel (inner tube extrusion step). Next, a reinforcing layer 12 is formed by braiding a predetermined number of brass-plated wires on the outer side of the rubber inner layer 11 formed in the inner tube extrusion step (braiding step), and then a rubber outer layer (jacket rubber) 13 is formed by extrusion molding the composition of the present embodiment on the outer side of the reinforcing layer 12 (jacket extrusion step). Thereafter, the outer side of the rubber outer layer 13 formed in the jacket extrusion step is covered with an appropriate resin (resin mold covering step), and then the resultant is vulcanization adhered by subjecting the resultant to press vulcanization, steam vulcanization, oven vulcanization (hot-air vulcanization), or hot water vulcanization under a predetermined condition (e.g. a temperature of 140° C. to 190° C., and heating time of 30 minutes to 180 minutes) (vulcanization step). After the vulcanization, the covering resin is peeled off (resin mold peeling step), and the mandrel is removed (mandrel removing step) to produce a hydraulic hose having the reinforcing layer 12 in between the rubber inner layer 11 and the rubber outer layer 13.

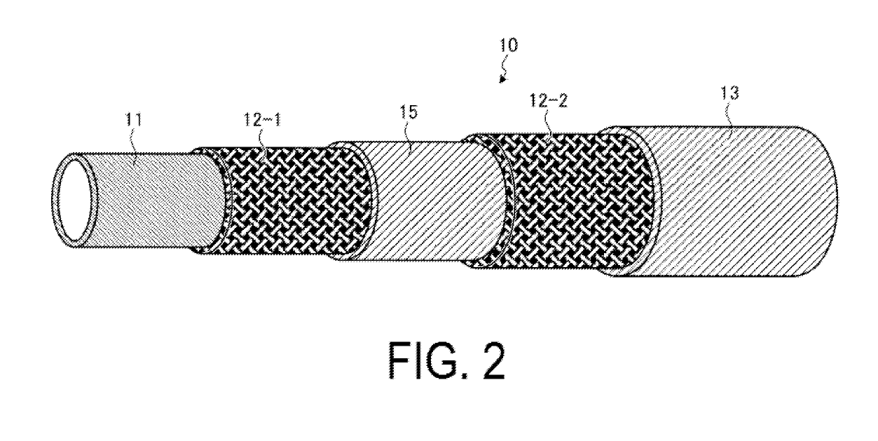

Note that, although the hose 10 of the present embodiment has a three-layer structure in which, from the inner side, the rubber inner layer 11, the reinforcing layer 12, and the rubber outer layer 13 are sequentially laminated as described above, for cases where further strength or the like is required, the hose 10 of the present embodiment can have a plurality of the reinforcing layers 12 described above, and a rubber intermediate layer (middle rubber) can be provided in between each of the reinforcing layers 12. The hose 10 of the present embodiment may have, for example, as illustrated in FIG. 2, a five-layer structure having, from the inner side, a rubber inner layer 11, a first reinforcing layer 12-1, a rubber intermediate layer 15, a second reinforcing layer 12-2, and a rubber outer layer 13 sequentially. The structure of the hose 10 of the present embodiment can appropriately adjust the number of the reinforcing layer 12 depending on required characteristics or the like of the hose.

At this time, the rubber composition used in the rubber intermediate layer 15 is preferably the rubber composition of the present embodiment. The rubber composition used in the rubber intermediate layer 15 is, for example, preferably a rubber composition having the 100% modulus (M₁₀₀) after vulcanization of 2 MPa or greater.

The hose 10 of the present embodiment can suppress generation of rust and progress of corrosion of brass-plated wires since penetration of water, such as salt water, from the outside to inside the hose 10 can be suppressed by forming the rubber layer (rubber inner layer 11 and rubber outer layer 13) using the rubber composition of the present embodiment. Therefore, the hose 10 of the present embodiment can exhibit excellent oil resistance and weatherability and maintain adhesion toward the reinforcing layer 12. Therefore, the hose 10 of the present embodiment can be used stably for a long period of time since the hose 10 has excellent durability against external environment.

Furthermore, a hose, such as a hydraulic hose placed at ports or similar places, is readily damaged by salts from salt water such as sea water. The damage by salt is caused when the salt water and the hose are brought into direct contact, when salt dispersed in the air transported by sea breezes is attached on a surface of a hose and then attached salt on the surface of the hose is dissolved to be salt-containing water when it rains and attaches on the surface of the hose, and when salt floated in the air precipitates with rain and attaches on the surface of the hose. Since the hose 10 of the present embodiment can exhibit excellent oil resistance and weatherability and maintain adhesion toward the reinforcing layer 12 as described above, it is possible to provide a highly reliable hydraulic hose even when used as a hose, such as a hydraulic hose, that is readily damaged by salts from salt water such as sea water.

### EXAMPLES

The composition of the present embodiment is described in detail below using Working Examples, but the present embodiment is not limited to these

### Working Examples

### Working Examples 1-1 to 1-3, Comparative Examples 1-1 to 1-8

Working Examples 1-1 to 1-3 and Comparative Examples 1-1 to 1-8 are examples using a rubber component containing CR and SBR as the rubber component (A). The rubber composition was prepared by compounding the components shown in Table 1 below at proportions (parts by mass) shown in Table 1 below. Specifically, a master batch was obtained by first kneading the components shown in Table 1 below, except for the sulfur and the vulcanization accelerator, for 5 minutes in a Banbury mixer (3.4 L), and then discharging the mixture when the temperature reached 160° C. Next, a rubber composition was obtained by adding the sulfur and the vulcanization accelerator to the obtained master batch and kneading using an open roll. The extrusion processability and appearance of the rubber obtained by each of the obtained rubber compositions were evaluated based on the following methods. The corrosion resistance of a rubber/wire composite obtained by using each of the rubber compositions was also evaluated. The added amounts (parts by mass) of the components and the results in the working examples and comparative examples are shown in Table 1.

### (Production of Rubber/Wire Composite)

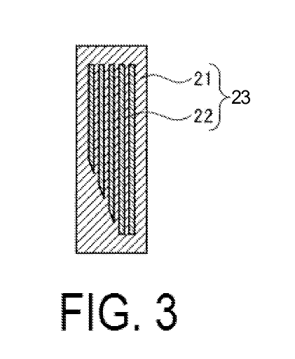

As illustrated in FIG. 3, a vulcanized product containing brass-plated wires 22 inside a rubber layer 21 (rubber/wire composite 23; 50 mm width×150 mm length×5 mm thickness) was produced by, after including brass (Cu—Zn alloy)-plated wires in between unvulcanized rubber sheets of each of the rubber compositions, hot-press-vulcanizing the resultant at 148° C. for 45 minutes.

### (Production of Salt Water for Corrosion Resistance Test)

Since the average salt concentration in sea water is 35%0, the salt water was prepared by mixing 35 g of refined salt in 1 L (1000 mL) of distilled water.

### [Evaluation of Physical Properties]

The extrusion processability and appearance of the rubber obtained by each of the obtained rubber compositions were evaluated. The corrosion resistance of a rubber/wire composite 23 was also evaluated. The evaluation results are shown in Table 1.

### (Corrosion Resistance)

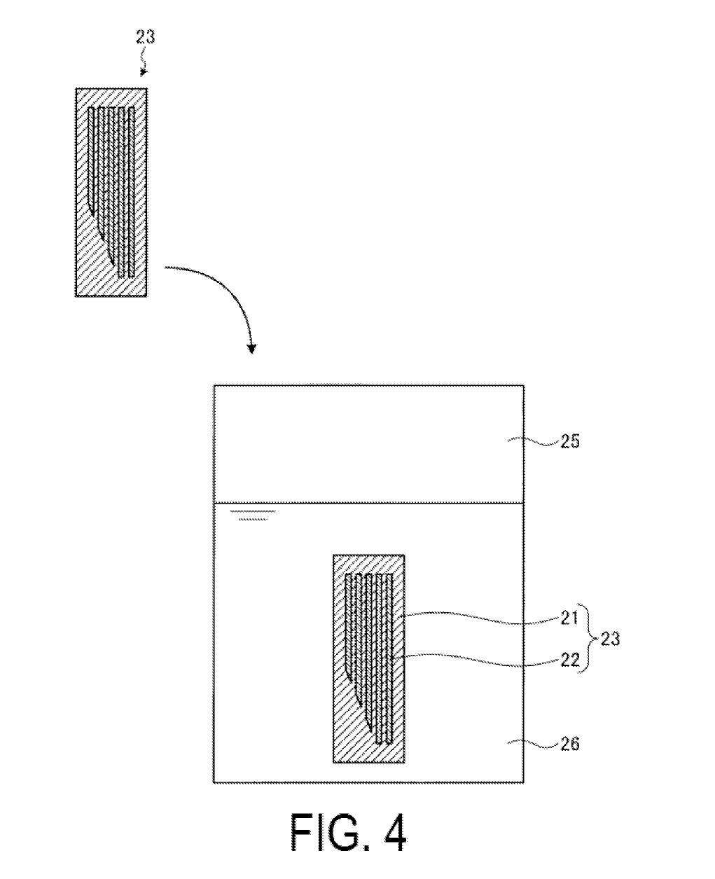

After placing the obtained rubber/wire composite 23 in a testing vessel, the inside temperature of the testing vessel was set to 100° C., and the composite was heated for 72 hours. After the rubber/wire composite 23 was thermally aged, the composite was removed from the testing vessel and cooled to room temperature. Thereafter, as illustrated in FIG. 4, the rubber/wire composite 23 was immersed in the salt water 26 in a container 25 for a predetermined time period (40° C., for 7 days to 28 days). The rubber/wire composite 23 was then removed from the salt water 26. Thereafter, the rubber layer 21 of the rubber/wire composite 23 was peeled off, and presence/absence of rust on the wires were visually observed. The results of the observation were evaluated by the following determination criteria. The results of the observation are shown in Table 1. The corrosion resistance is considered to be excellent for cases where no rust was observed on the wires.

### Determination Criteria

o: No rust was observed on the wires
Δ: A little amount of rust was observed scattered on the wires
x: A large amount of rust was observed scattered on the wires

### (Extrusion Processability)

The obtained unvulcanized rubber was fed in an extruder to perform extrusion-processing, and ease of molding was evaluated by the following determination criteria. The results are shown in Table 1. The extrusion processability is considered to be excellent for cases where the rubber was easily processed.

### Determination Criteria

o: It was easy to process
x: It was hard to process

### (Appearance)

The surface condition of the rubber after the extrusion-processing was visually observed and evaluated by the following determination criteria. The results of the observation are shown in Table 1. The appearance is considered to be excellent for cases where no defects, such as a crack or deformation of the shape, were observed on the surface of the rubber.

o: No defects, such as a crack or deformation of the shape, were observed on the molded body
x: Defects, such as a crack or deformation of the shape, were observed on the molded body

TABLE 1

| | | Working | Working | Working | Comparative |
|---|---|---|---|---|---|
| | | Example 1-1 | Example 1-2 | Example 1-3 | Example 1-1 |
| Rubber component | SBR | 50 | 0 | 20 | 40 |
| (A) | CR | 50 | 100 | 80 | 60 |
| FEF carbon black | | 90 | 90 | 90 | 90 |
| Magnesium oxide | | 3 | 3 | 3 | 4 |
| Zinc oxide | | 5 | 5 | 5 | 5 |
| Stearic acid | | 1 | 1 | 1 | 1 |
| Paraffin wax SUNTIGHT R | | 2 | 2 | 2 | 2 |
| Paraffin wax SUNNOC | | 1 | 1 | 1 | 1 |
| Antiozonant | | 2 | 2 | 2 | 2 |
| Water repellent | UHMWPE powder | 10 | 0 | 10 | 0 |
| (B) 1 | | | | | |
| Water repellent | Fatty acid | 0 | 8 | 5 | 0 |
| (B) 2 | amide compound | | | | |
| Hydrotalcite (C) | | 10 | 12 | 10 | 0 |
| Naphthenic oil | | 10 | 10 | 10 | 10 |
| Aroma oil | | 11 | 11 | 11 | 25 |
| Sulfur | | 0.75 | 0.75 | 0.75 | 0.75 |
| Vulcanization accelerator 1 | | 0.75 | 0.75 | 0.75 | 0.75 |
| Vulcanization accelerator 2 | | 0.75 | 0.75 | 0.75 | 0.75 |
| Corrosion | 0 days | ∘ | ∘ | ∘ | ∘ |
| resistance | 7 days | ∘ | ∘ | ∘ | Δ |
| | 14 days | ∘ | ∘ | ∘ | x |
| | 21 days | ∘ | ∘ | ∘ | x |
| | 28 days | ∘ | ∘ | ∘ | x |
| Extrusion processability | | ∘ | ∘ | ∘ | ∘ |
| Appearance | | ∘ | ∘ | ∘ | ∘ |
| | | Comparative | Comparative | Comparative | Comparative |
| | | Example 1-2 | Example 1-3 | Example 1-4 | Example 1-5 |
| Rubber component | SBR | 40 | 40 | 40 | 20 |
| (A) | CR | 60 | 60 | 60 | 80 |
| FEF carbon black | | 90 | 90 | 90 | 90 |
| Magnesium oxide | | 4 | 4 | 4 | 3 |
| Zinc oxide | | 5 | 5 | 5 | 5 |
| Stearic acid | | 1 | 1 | 1 | 1 |
| Paraffin wax SUNTIGHT R | | 2 | 2 | 2 | 2 |
| Paraffin wax SUNNOC | | 1 | 1 | 1 | 1 |
| Antiozonant | | 2 | 2 | 2 | 2 |
| Water repellent | UHMWPE powder | 10 | 0 | 0 | 12 |
| (B) 1 | | | | | |
| Water repellent | Fatty acid | 0 | 5 | 0 | 5 |
| (B) 2 | amide compound | | | | |
| Hydrotalcite (C) | | 0 | 0 | 10 | 0 |
| Naphthenic oil | | 10 | 10 | 10 | 10 |
| Aroma oil | | 11 | 25 | 25 | 11 |
| Sulfur | | 0.75 | 0.75 | 0.75 | 0.75 |
| Vulcanization accelerator 1 | | 0.75 | 0.75 | 0.75 | 0.75 |
| Vulcanization accelerator 2 | | 0.75 | 0.75 | 0.75 | 0.75 |
| Corrosion | 0 days | ∘ | ∘ | ∘ | ∘ |
| resistance | 7 days | ∘ | ∘ | ∘ | ∘ |
| | 14 days | Δ | Δ | ∘ | ∘ |
| | 21 days | x | x | Δ | Δ |
| | 28 days | x | x | x | x |

| | | | | |
|---|---|---|---|---|
| Extrusion processability | ∘ | ∘ | ∘ | ∘ |
| Appearance | ∘ | ∘ | ∘ | ∘ |

| | | Comparative | Comparative | Comparative |
|---|---|---|---|---|
| | | Example 1-6 | Example 1-7 | Example 1-8 |
| Rubber component | SBR | 40 | 40 | 40 |
| (A) | CR | 60 | 60 | 60 |
| FEF carbon black | | 90 | 90 | 90 |
| Magnesium oxide | | 3 | 3 | 3 |
| Zinc oxide | | 5 | 5 | 5 |
| Stearic acid | | 1 | 1 | 1 |
| Paraffin wax SUNTIGHT R | | 2 | 2 | 2 |
| Paraffin wax SUNNOC | | 1 | 1 | 1 |
| Antiozonant | | 2 | 2 | 2 |
| Water repellent | UHMWPE powder | 1 | 15 | 10 |
| (B) 1 | | | | |
| Water repellent | Fatty acid | 0 | 20 | 5 |
| (B) 2 | amide compound | | | |
| Hydrotalcite (C) | | 1 | 10 | 25 |
| Naphthenic oil | | 10 | 10 | 10 |
| Aroma oil | | 11 | 11 | 11 |
| Sulfur | | 0.75 | 0.75 | 0.75 |
| Vulcanization accelerator 1 | | 0.75 | 0.75 | 0.75 |
| Vulcanization accelerator 2 | | 0.75 | 0.75 | 0.75 |
| Corrosion | 0 days | ∘ | ∘ | ∘ |
| resistance | 7 days | Δ | ∘ | ∘ |
| | 14 days | x | ∘ | ∘ |
| | 21 days | x | ∘ | ∘ |
| | 28 days | x | ∘ | ∘ |

| | | | |
|---|---|---|---|
| Extrusion processability | ∘ | ∘ | x |
| Appearance | ∘ | x | ∘ |

The components shown in Table 1 are as follows.
SBR: Nipol 1502, manufactured by Zeon Corporation; emulsion polymerization SBR; bonded styrene content: 23.5 mass %; Mooney viscosity ML1+4 (100° C.): 52
CR: Denka Chloroprene S-41, manufactured by Denki Kagaku Kogyo K.K; Mooney viscosity ML1+4 (100° C.): 48
FEF carbon black: HTC#100, manufactured by NSCC Carbon Co., Ltd.
Magnesium oxide (MgO): Kyowa Mag 150, manufactured by Kyowa Chemical Industry Co., Ltd.
Zinc oxide (ZnO): Type III zinc oxide, manufactured by Seido Chemical Industry Co., Ltd.
Stearic acid: Industrial stearic acid N, manufactured by Chiba Fatty Acid Co., Ltd.
Paraffin wax SUNTIGHT R: manufactured by Seiko Chemical Co., Ltd.
Paraffin wax SUNNOC: manufactured by Ouchi Shinko Chemical Industrial Co., Ltd.
Antiozonant: OZONONE 6C, manufactured by Seiko Chemical Co., Ltd.
Water repellent (B) 1: UHMWPE powder (trade name: Mipelon XM-200; viscosity average molecular weight: 2,000,000; average particle size: 30 μm; manufactured by Mitsui Chemicals, Inc.)
Water repellent (B) 2: Fatty acid amide compound (trade name: ARMOSLIP CP Powder, manufactured by Lion Akzo Co., Ltd.)
Hydrotalcite (C): DHT-4A, manufactured by Kyowa Chemical Industry Co., Ltd.
Naphthenic oil: Komorex H22, manufactured by Fuji Kosan Co., Ltd.
Aroma oil: A-OMIX, manufactured by Sankyo Yuka Kogyo K.K.
Sulfur: manufactured by Hosoi Chemical Industry Co., Ltd.
Vulcanization accelerator 1 (tetramethylthiuram monosulfide): NOCCELER TS, manufactured by Ouchi Shinko Chemical Industrial Co., Ltd.
Vulcanization accelerator 2 (Diphenylguanidine): NOCCELER D, manufactured by Ouchi Shinko Chemical Industrial Co., Ltd.

As is clear from the results shown in Table 1, the rubber/wire composites 23 (Comparative Examples 1-1 to 1-5) produced by using the rubber compositions in which both of or at least one of the water repellent (B) and the hydrotalcite (C) was not contained exhibited insufficient corrosion resistance. Furthermore, even in the rubber/wire composites 23 (Comparative Examples 1-6 to 1-8) produced by using the rubber compositions in which both of the water repellent (B) and the hydrotalcite (C) were contained, for cases where at least one of the content of the water repellent (B) or the hydrotalcite (C) was excessively large or excessively little, one of corrosion resistance, extrusion processability, and appearance was insufficient. That is, in the rubber/wire composite 23 (Comparative Example 1-6) produced by using the rubber composition in which both of the contents of the water repellent (B) and the hydrotalcite (C) were excessively little, corrosion resistance was insufficient. Furthermore, in the rubber/wire composite 23 (Comparative Example 1-7) produced by using the rubber composition in which the content of the water repellent (B) was excessively large, although corrosion resistance was sufficient, appearance of the rubber was insufficient. Furthermore, in the rubber/wire composite 23 (Comparative Example 1-8) produced by using the rubber composition in which the content of the hydrotalcite (C) was excessively large, although corrosion resistance was sufficient, rubber processability was insufficient.

On the other hand, in the rubber/wire composites 23 (Working Examples 1-1 to 1-3) produced by using the rubber compositions containing predetermined amounts of both the water repellent (B) and the hydrotalcite (C), all of corrosion resistance, extrusion processability, and appearance were excellent.

Therefore, it was confirmed that a vulcanized product produced by using a rubber composition containing the rubber component (A), the water repellent (B), and the hydrotalcite (C) at predetermined proportions, each described above, exhibited high weatherability, maintained adhesion toward brass, and exhibits excellent durability against external environment. This is because it was possible to suppress generation of rust on the brass-plated wires 22 in the rubber layer 21 by suppressing permeation of the salt water 26 from the surface of the rubber layer 21.

### Working Examples 2-1 to 2-3, Comparative Examples 2-1 to 2-8

Working Examples 2-1 to 2-3 and Comparative Examples 2-1 to 2-8 are examples using a rubber component containing EPDM, NBR, and SBR as the rubber component (A). The method of producing the rubber compositions was the same as the method described in “Working Examples 1-1 to 1-3, Comparative Examples 1-1 to 1-8” above. The added amounts (parts by mass) of the components and the results in the working examples and comparative examples are shown in Table 2.

### (Production of Rubber/Wire Composite)

The method of producing the rubber/wire composite using the rubber compositions was the same as the method described in “Working Examples 1-1 to 1-3, Comparative Examples 1-1 to 1-8” above.

### [Evaluation of Physical Properties]

Processability and appearance of rubber obtained by each of the obtained rubber compositions, and Corrosion resistance of the rubber/wire composite 23 were evaluated in the same manner as in “Working Examples 1-1 to 1-3, Comparative Examples 1-1 to 1-8” above.

### (Processability)

Processability was evaluated in the same manner as in “Working Examples 1-1 to 1-3, Comparative Examples 1-1 to 1-8” above. The results are shown in Table 2.

### (Appearance)

Appearance was evaluated in the same manner as in “Working Examples 1-1 to 1-3, Comparative Examples 1-1 to 1-8” above. The results are shown in Table 2.

TABLE 2

| | | Working | Working | Working | Comparative |
|---|---|---|---|---|---|
| | | Example 2-1 | Example 2-2 | Example 2-3 | Example 2-1 |
| Rubber component | SBR | 30 | 30 | 30 | 30 |
| (A) | NBR | 40 | 40 | 40 | 40 |
| | EPDM | 30 | 30 | 30 | 30 |
| ISAF carbon black | | 60 | 60 | 60 | 60 |
| Zinc oxide | | 5 | 5 | 5 | 5 |
| Stearic acid | | 1 | 1 | 1 | 1 |
| Paraffin wax SUNTIGHT R | | 2 | 2 | 2 | 2 |
| Paraffin wax SUNNOC | | 1 | 1 | 1 | 1 |
| Antiozonant | | 2 | 2 | 2 | 2 |
| Water repellent | UHMWPE powder | 10 | 0 | 10 | 0 |
| (B) 1 | | | | | |
| Water repellent | Fatty acid | 0 | 8 | 5 | 0 |
| (B) 2 | amide compound | | | | |
| Hydrotalcite (C) | | 10 | 12 | 10 | 0 |
| Plasticizer DOA | | 10 | 10 | 10 | 10 |
| Aroma oil | | 12 | 12 | 12 | 12 |
| Sulfur | | 2 | 2 | 2 | 2 |
| Vulcanization accelerator 3 | | 1.5 | 1.5 | 1.5 | 1.5 |
| Antiscorching agent | | 0.2 | 0.2 | 0.2 | 0.2 |
| Corrosion | 0 days | ∘ | ∘ | ∘ | ∘ |
| resistance | 7 days | ∘ | ∘ | ∘ | Δ |
| | 14 days | ∘ | ∘ | ∘ | x |
| | 21 days | ∘ | ∘ | ∘ | x |
| | 28 days | ∘ | ∘ | ∘ | x |
| Extrusion processability | | ∘ | ∘ | ∘ | ∘ |
| Appearance | | ∘ | ∘ | ∘ | ∘ |
| | | Comparative | Comparative | Comparative | Comparative |
| | | Example 2-2 | Example 2-3 | Example 2-4 | Example 2-5 |
| Rubber component | SBR | 30 | 30 | 30 | 30 |
| (A) | NBR | 40 | 40 | 40 | 40 |
| | EPDM | 30 | 30 | 30 | 30 |
| ISAF carbon black | | 60 | 60 | 60 | 60 |
| Zinc oxide | | 5 | 5 | 5 | 5 |
| Stearic acid | | 1 | 1 | 1 | 1 |
| Paraffin wax SUNTIGHT R | | 2 | 2 | 2 | 2 |
| Paraffin wax SUNNOC | | 1 | 1 | 1 | 1 |
| Antiozonant | | 2 | 2 | 2 | 2 |
| Water repellent | UHMWPE powder | 10 | 0 | 0 | 12 |
| (B) 1 | | | | | |
| Water repellent | Fatty acid | 0 | 5 | 0 | 5 |
| (B) 2 | amide compound | | | | |
| Hydrotalcite (C) | | 0 | 0 | 10 | 0 |
| Plasticizer DOA | | 10 | 10 | 10 | 10 |
| Aroma oil | | 12 | 12 | 12 | 12 |
| Sulfur | | 2 | 2 | 2 | 2 |
| Vulcanization accelerator 3 | | 1.5 | 1.5 | 1.5 | 1.5 |
| Antiscorching agent | | 0.2 | 0.2 | 0.2 | 0.2 |
| Corrosion | 0 days | ∘ | ∘ | ∘ | ∘ |
| resistance | 7 days | ∘ | ∘ | ∘ | ∘ |
| | 14 days | Δ | Δ | ∘ | ∘ |
| | 21 days | x | x | Δ | Δ |
| | 28 days | x | x | x | x |

| | | | | |
|---|---|---|---|---|
| Extrusion processability | ∘ | ∘ | ∘ | ∘ |
| Appearance | ∘ | ∘ | ∘ | ∘ |

| | | Comparative | Comparative | Comparative |
|---|---|---|---|---|
| | | Example 2-6 | Example 2-7 | Example 2-8 |
| Rubber component | SBR | 30 | 30 | 30 |
| (A) | NBR | 40 | 40 | 40 |
| | EPDM | 30 | 30 | 30 |
| ISAF carbon black | | 60 | 60 | 60 |
| Zinc oxide | | 5 | 5 | 5 |
| Stearic acid | | 1 | 1 | 1 |
| Paraffin wax SUNTIGHT R | | 2 | 2 | 2 |
| Paraffin wax SUNNOC | | 1 | 1 | 1 |
| Antiozonant | | 2 | 2 | 2 |
| Water repellent | UHMWPE powder | 1 | 15 | 10 |
| (B) 1 | | | | |
| Water repellent | Fatty acid | 0 | 20 | 5 |
| (B) 2 | amide compound | | | |
| Hydrotalcite (C) | | 1 | 10 | 25 |
| Plasticizer DOA | | 10 | 10 | 10 |
| Aroma oil | | 12 | 12 | 12 |
| Sulfur | | 2 | 2 | 2 |
| Vulcanization accelerator 3 | | 1.5 | 1.5 | 1.5 |
| Antiscorching agent | | 0.2 | 0.2 | 0.2 |
| Corrosion | 0 days | ∘ | ∘ | ∘ |
| resistance | 7 days | Δ | ∘ | ∘ |
| | 14 days | x | ∘ | ∘ |
| | 21 days | x | ∘ | ∘ |
| | 28 days | x | ∘ | ∘ |

| | | | |
|---|---|---|---|
| Extrusion processability | ∘ | ∘ | x |
| Appearance | ∘ | x | ∘ |

The components shown in Table 2 are as follows.
SBR: Nipol 1502, manufactured by Zeon Corporation; emulsion polymerization SBR; bonded styrene content: 23.5 mass %; Mooney viscosity ML1+4 (100° C.): 52
NBR: Perbunan 2845 F, manufactured by Lanxess; acrylonitrile content: 28 mass %; Mooney viscosity ML1+4 (100° C.): 45
EPDM: EPT4070, manufactured by Mitsui Chemicals, Inc.; ethylene content: 54 mass %; ethylidene norbornene content: 9 mass %; Mooney viscosity ML1+4 (125° C.): 47
ISAF carbon black: Shoblack N220, manufactured by Showa Cabot K.K.
Zinc oxide: “Zinc Oxide #3”, manufactured by Seido Chemical Industry Co., Ltd.
Stearic acid: Industrial stearic acid N, manufactured by Chiba Fatty Acid Co., Ltd.
Paraffin wax SUNTIGHT R: manufactured by Seiko Chemical Co., Ltd.
Paraffin wax SUNNOC: manufactured by Ouchi Shinko Chemical Industrial Co., Ltd.
Antiozonant: OZONONE 6C, manufactured by Seiko Chemical Co., Ltd.
Water repellent (B) 1: UHMWPE powder (trade name: Mipelon XM-200; viscosity average molecular weight: 2,000,000; average particle size: 30 μm; manufactured by Mitsui Chemicals, Inc.)
Water repellent (B) 2: Fatty acid amide compound (trade name: ARMOSLIP CP Powder, manufactured by Lion Akzo Co., Ltd.)
Hydrotalcite (C): DHT-4A, manufactured by Kyowa Chemical Industry Co., Ltd.
Plasticizer DOA: DIACIZER DOA, manufactured by Mitsubishi Kasei Vinyl Company
Aroma oil: A-OMIX, manufactured by Sankyo Yuka Kogyo K.K.
Sulfur: manufactured by Hosoi Chemical Industry Co., Ltd.
Vulcanization accelerator 3 (N-t-butylbenzothiazol-2-sulfenamide): NOCCELER NS-P, manufactured by Ouchi Shinko Chemical Industrial Co., Ltd.
Antiscorching agent: N-cyclohexylthiophthalimide, manufactured by FLEXSYS

As is clear from the results shown in Table 2, the rubber/wire composites 23 (Comparative Examples 2-1 to 2-5) produced by using the rubber compositions in which both of or at least one of the water repellent (B) and the hydrotalcite (C) was not contained exhibited insufficient corrosion resistance. Furthermore, even in the rubber/wire composites 23 (Comparative Examples 2-6 to 2-8) produced by using the rubber compositions in which both of the water repellent (B) and the hydrotalcite (C) were contained, for cases where at least one of the content of the water repellent (B) or the hydrotalcite (C) was excessively large or excessively little, one of corrosion resistance, extrusion processability, and appearance was insufficient. That is, in the rubber/wire composite 23 (Comparative Example 2-6) produced by using the rubber composition in which both of the contents of the water repellent (B) and the hydrotalcite (C) were excessively little, corrosion resistance was insufficient. Furthermore, in the rubber/wire composite 23 (Comparative Example 2-7) produced by using the rubber composition in which the content of the water repellent (B) was excessively large, although corrosion resistance was sufficient, appearance of the rubber was insufficient. Furthermore, in the rubber/wire composite 23 (Comparative Example 2-8) produced by using the rubber composition in which the content of the hydrotalcite (C) was excessively large, although corrosion resistance was sufficient, extrusion processability was insufficient.

On the other hand, in the rubber/wire composites 23 (Working Examples 2-1 to 2-3) produced by using the rubber compositions containing predetermined amounts of both the water repellent (B) and the hydrotalcite (C), all of corrosion resistance, extrusion processability, and appearance were excellent.

Therefore, it was confirmed that a vulcanized product produced by using a rubber composition containing the rubber component (A), the water repellent (B), and the hydrotalcite (C) at predetermined proportions, each described above, exhibited high weatherability, maintained adhesion toward brass, and exhibits excellent durability against external environment. This is because it was possible to suppress generation of rust on the brass-plated wires 22 in the rubber layer 21 by suppressing permeation of the salt water 26 from the surface of the rubber layer 21.

1. A rubber composition comprising: a rubber component (A), a water repellent (B), and hydrotalcite (C);
the rubber component (A) comprising chloroprene rubber, styrene-butadiene rubber, or both chloroprene rubber and styrene-butadiene rubber;
the water repellent (B) comprising one or more types of ultra high molecular weight polyethylene powders or fatty acid amide compounds;
a total content of the components of the water repellent (B) being from 2 parts by mass to 30 parts by mass per 100 parts by mass of the rubber component (A); and
a content of the hydrotalcite (C) being from 2 parts by mass to 20 parts by mass per 100 parts by mass of the rubber component (A).

2. A rubber composition comprising: a rubber component (A), a water repellent (B), and hydrotalcite (C);
the rubber component (A) comprising ethylene-propylene-non-conjugated diene rubber, acrylonitrile-butadiene rubber, and styrene-butadiene rubber;
the water repellent (B) comprising one or more types of ultra high molecular weight polyethylene powders or fatty acid amide compounds;
a content of the ethylene-propylene-non-conjugated diene rubber in the rubber component (A) being from 20 parts by mass to 35 parts by mass, a content of the acrylonitrile-butadiene rubber being from 30 parts by mass to 50 parts by mass, and a content of the styrene-butadiene rubber being from 25 parts by mass to 50 parts by mass;
a total content of the components of the water repellent (B) being from 2 parts by mass to 30 parts by mass per 100 parts by mass of the rubber component (A); and
a content of the hydrotalcite (C) being from 2 parts by mass to 20 parts by mass per 100 parts by mass of the rubber component (A).

3. The rubber composition according to claim 1, wherein, upon the rubber component (A) comprising both the chloroprene rubber and the styrene-butadiene rubber,
a content of the chloroprene rubber is 40 parts by mass or greater but less than 100 parts by mass, and a content of the styrene-butadiene rubber is greater than 0 parts by mass but 60 parts by mass or less.

4. The rubber composition according to claim 1, wherein the rubber composition is a rubber composition for a hose.

5. A vulcanized rubber product obtained by vulcanizing the rubber composition described in claim 1.

6. The vulcanized rubber product according to claim 5, comprising a rubber layer obtained by vulcanizing the rubber composition described in claim 1, and a reinforcing layer having a brass-plated surface disposed adjacent to the rubber layer.

7. The vulcanized rubber product according to claim 5, wherein the vulcanized rubber product is a hose.

8. The vulcanized rubber product according to claim 5, wherein the vulcanized rubber product is a hydraulic hose.

9. A hose comprising: a rubber inner layer, a reinforcing layer having a brass-plated surface disposed adjacent to an outer circumferential side of the rubber inner layer, and an rubber outer layer disposed adjacent to an outer circumferential side of the reinforcing layer;
the rubber inner layer, the rubber outer layer, or both the rubber inner layer and the rubber outer layer being formed by the rubber composition described in claim 1.

10. The rubber composition according to claim 2, wherein the rubber composition is a rubber composition for a hose.

11. A vulcanized rubber product obtained by vulcanizing the rubber composition described in claim 10.

12. The vulcanized rubber product according to claim 11, comprising a rubber layer obtained by vulcanizing the rubber composition described in claim 2, and a reinforcing layer having a brass-plated surface disposed adjacent to the rubber layer.

13. The rubber composition according to claim 3, wherein the rubber composition is a rubber composition for a hose.

14. A vulcanized rubber product obtained by vulcanizing the rubber composition described in claim 13.

15. The vulcanized rubber product according to claim 14, comprising a rubber layer obtained by vulcanizing the rubber composition described in claim 3, and a reinforcing layer having a brass-plated surface disposed adjacent to the rubber layer.

16. A vulcanized rubber product obtained by vulcanizing the rubber composition described in claim 4.

17. The vulcanized rubber product according to claim 16, comprising a rubber layer obtained by vulcanizing the rubber composition described in claim 4, and a reinforcing layer having a brass-plated surface disposed adjacent to the rubber layer.

18. The vulcanized rubber product according to claim 6, wherein the vulcanized rubber product is a hose.

19. The vulcanized rubber product according to claim 6, wherein the vulcanized rubber product is a hydraulic hose.

20. A hose comprising: a rubber inner layer, a reinforcing layer having a brass-plated surface disposed adjacent to an outer circumferential side of the rubber inner layer, and an rubber outer layer disposed adjacent to an outer circumferential side of the reinforcing layer;
the rubber inner layer, the rubber outer layer, or both the rubber inner layer and the rubber outer layer being formed by the rubber composition described in claim 2.
